(19) United States
(12) Patent Application Publication
(10) Pub. No.: US 2019/0390961 A1
(43) Pub. Date: Dec. 26, 2019

(54) METHOD FOR VERIFYING THE ABILITY OF AN AIRCRAFT TO ATTAIN AN ENDPOINT, METHOD FOR DETERMINING AN ATTAINABLE AREA, ASSOCIATED COMPUTER PROGRAM PRODUCT AND ANALYSING SYSTEM

(71) Applicant: Thales, Courbevoie (FR)

(72) Inventors: Dorian Martinez, Toulouse (FR); Stéphane Giraudeau, Toulouse (FR)

(21) Appl. No.: 16/442,136

(22) Filed: Jun. 14, 2019

(30) Foreign Application Priority Data
Jun. 20, 2018 (FR) 18 00635

(51) Int. Cl. G01C 21/20; G08G 5/00

(52) U.S. Cl. CPC G01C 21/20; G08G 5/003

(57) ABSTRACT

The present invention relates to a method for verifying the ability of an aircraft to attain an endpoint from a starting point, comprising the steps of supplying an external evolution context of the aircraft, supplying an internal evolution context of the aircraft; calculating a trajectory of the aircraft between the starting point and the endpoint according to the external evolution context and the internal evolution context of the aircraft and according to a predetermined strategy for circumventing three-dimensional obstacles and associating an endpoint attainability state.

When there is at least one trajectory between the starting point and the endpoint, the method further comprising a step of estimating a surplus of energy of the aircraft at the endpoint of the calculated trajectory.

### FIELD OF THE INVENTION

The present invention relates to a method for verifying the ability of an aircraft to attain an endpoint.

The present invention also relates to a method for determining an attainable area, a computer program product, and an associated analysing system. In particular, the invention relates to either on-board avionics systems involving a navigation computer such as, for example, an FMS (Flight Management System) computer, or to computer systems capable of modeling the performance of an aircraft and, more particularly, to an environment comprising modeled onboard avionics systems integrating a navigation computer model such as, for example, the SDK (Software Development Kit) environment for the FMS computer.

The invention makes it possible to check the ability of the aircraft to attain an endpoint from a starting point and thus to determine all the points attainable by an aircraft from this starting point.

### BACKGROUND OF THE INVENTION

Solutions already exist in the prior art for representing in graphical form, all the points attainable by the aircraft while assuming that all the engines are stopped.

In addition, some navigation computers allow calculation of the prediction of fuel remaining at an endpoint under the existing external and internal conditions. These existing conditions include, in particular, the state of operation of various components of the aircraft, information on the terrain overflown by the aircraft, weather conditions, etc. These conditions may be real or simulated (also known as “what-if” conditions).

In general, this type of computer makes it possible, in particular, to predict the fuel remaining at the endpoint.

However, existing solutions are not completely satisfactory.

In particular, the trajectory of the aircraft calculated according to existing solutions from the starting point to the endpoint takes into account the altitude of the terrain at the destination but does not take into account any intermediate constraints along the trajectory. Thus, considering, for example, the relief of the terrain as an external constraint, the predictions made by existing solutions do not take into account the circumvention of a possible relief of the terrain located along the trajectory. These predictions may therefore indicate an airport located on the other side of a mountain range, when in reality, no trajectory could attain it with the available energy.

In addition, existing solutions do not compare the energy consumption of the aircraft required to attain two different points while respecting all the external and internal constraints applied to the aircraft. This could, for example, make it possible to classify nearby airports by energy consumption as part of the search for a circumventing airport.

### SUMMARY OF THE INVENTION

The present invention aims to allow the pilot of the aircraft, firstly, to see energy predictions close to reality for any endpoint, and secondly, to see all the endpoints attainable from a starting point that presents, for example, the current position of the aircraft.

To this end, the object of the invention relates to a method for verifying the ability of an aircraft to attain an endpoint from a starting point.

The method comprising the following steps:
providing an external context for the evolution of the aircraft comprising external constraints of the aircraft that are capable of impacting the trajectory of the aircraft between the starting point and the endpoint, the external constraints comprising three-dimensional obstacles;
providing an internal context for the evolution of the aircraft comprising internal constraints of the aircraft capable of impacting the trajectory of the aircraft between the starting point and the endpoint;
calculating a trajectory of the aircraft between the starting point and the endpoint according to the external evolution context and the internal evolution context of the aircraft, and according to a predetermined strategy for circumventing three-dimensional obstacles;
when there is at least one trajectory between the starting point and the endpoint, estimating surplus energy of the aircraft at the endpoint of the calculated trajectory; and
associating an attainability state with the endpoint, wherein each attainability state is selected between an attainable state or a non-attainable state, the attainable state being chosen when there is at least one trajectory between the starting point and the endpoint, while the non-attainable state is selected in the opposite case.

According to other advantageous aspects of the invention, the method for verifying comprising one or more of the following characteristics, taken separately or in any technically feasible combination:
the step of associating a state at the endpoint that is additionally implemented as a function of a required energy margin at the endpoint;
the external constraints furthermore comprise the external weather conditions and the relief of the terrain between the starting point and the endpoint;
the internal constraints of the aircraft are defined by the operating state of various components of the aircraft;
the predetermined strategy for circumventing three-dimensional obstacles comprising a plurality of rules defining a vertical profile of the aircraft related to a lateral profile; and the step of calculating a trajectory of the aircraft between the starting point and the endpoint comprising the following substeps:
   calculating a lateral profile of the aircraft according to the external evolution context and the internal evolution context of the aircraft;
   calculating a vertical profile of the aircraft according to the external evolution context and the internal evolution context of the aircraft, and applying the predetermined strategy for circumventing three-dimensional obstacles to the lateral profile of the aircraft;

The invention also aims at a method for determining an area on the ground that is attainable by an aircraft from a starting point, comprising the iterative implementation of a previously-described method for verifying for said starting point and for an endpoint on the ground, wherein the chosen endpoint is different for each new iteration of the method for verifying.

According to other advantageous aspects of the invention, the determination method comprises one or more of the following characteristics, taken in isolation or in any technically feasible combination:
the predetermined strategy for circumventing three-dimensional obstacles comprising a plurality of rules defining a vertical profile of the aircraft related to a lateral profile;
the determination method comprising the following steps:
A) propagation of the aircraft from the starting point comprising the following substeps:
   forming a plurality of radii around the starting point of the aircraft;
   for each radius, identification of an endpoint having the non-attainable state, the non-attainable state of the contact point being determined by implementing the method for verifying as described above in which the lateral profile of the aircraft is calculated as a part of the radius;
   for each endpoint having the non-attainable state, analysis of the vertical profile and identification of a point of contact of this profile with the ground;
B) determining a boundary formed by one and several lines passing through all the points of contact;
C) delimitation of the area attainable by the boundary; and
when, during step B, at least one line forming the boundary has an unclosed line, step A) is again implemented for one of the ends of the unclosed line that is considered as the starting point during this implementation, step B) being then implemented again until the, or each, line forming the border, is closed.

The invention also relates to a computer program product comprising software instructions which, when implemented by computer equipment, implement the method of determination as defined above.

The invention also relates to an analysing system comprising means designed to implement the method of determination as defined above.

### BRIEF DESCRIPTION OF THE DRAWINGS

These features and advantages of the invention will become apparent upon reading the description which follows, given solely by way of non-limiting example, and with reference to the appended drawings, wherein:

FIG. 1 shows a schematic view of an analysing system according to the invention, the analysing system comprising, in particular, a first processing module and a second processing module;

FIG. 2 shows a flowchart of a method for verifying according to the invention, said method being implemented uses the first processing module of FIG. 1;

FIG. 3 shows a flowchart of a method for determining according to the invention, said method being implemented uses the second processing module of FIG. 1; and

FIGS. 4 and 5 show schematic views illustrating the implementation of the said method for determining of FIG. 3.

### DETAILED DESCRIPTION OF THE INVENTION

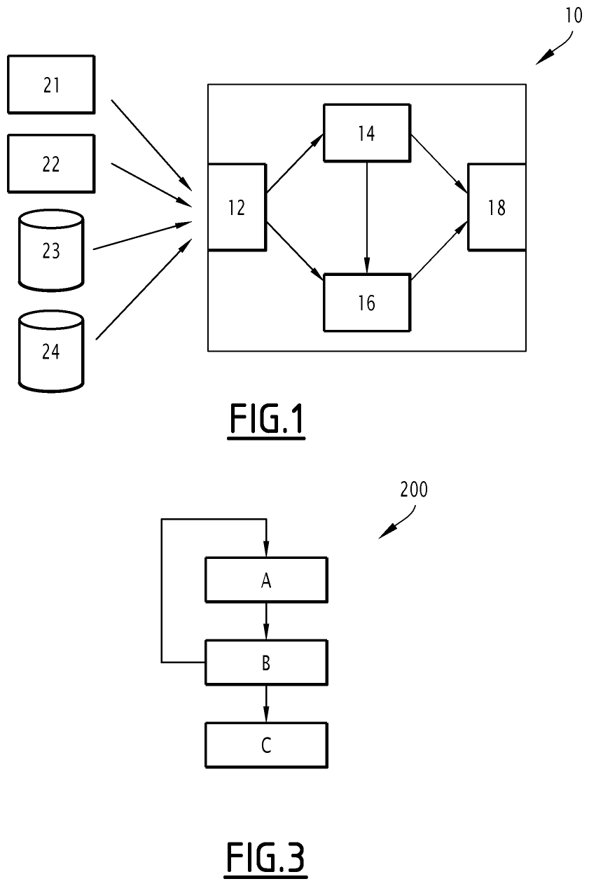

The analysing system 10 of FIG. 1 makes it possible to check the ability of an aircraft to attain an endpoint from a starting point and to determine all the points attainable by the aircraft from this starting point.

By “aircraft” is meant any device flying at least in the Earth's atmosphere and controllable by a pilot directly from the cockpit of the latter or at a distance. In the first case it is, in particular, an airplane or a helicopter. In the second case it is, in particular, a drone.

In the example described, the analysing system 10 is a system on board the aircraft. According to other exemplary embodiments (not described hereinafter), the analysing system 10 may relate to any other external system of the aircraft, possibly modeling a navigation computer such as for example the FMS computer.

With reference to FIG. 1, the analysing system 10 comprises an acquisition module 12, a first processing module 14, a second processing module 16 and an output module 18. According to an exemplary embodiment, the analysing system 10 may be in the form of an independent computer further comprising at least one processor and one memory. In this case, the aforementioned modules are at least partially in the form of programmable logic circuits of the FPGA (Field-Programmable Gate Array) type and/or software stored in the computer's memory and executable by the computer's processor.

According to another exemplary embodiment, the analysing system 10 is implemented by another onboard computer, for example by the FMS computer. In this case, the aforementioned modules are at least partially in the form of software instructions stored in a memory of such a computer and executable by a processor thereof.

The acquisition module 12 makes it possible to acquire all the external data of the analysing system 10 necessary for the operation thereof.

In particular, with reference to FIG. 1, the acquisition module 12 is connected to an input data supply unit 21, a unit 22 for supplying evolution contexts of the aircraft, a database of strategies 23, and a database of standards 24.

The input data supply unit 21 has, for example, a human-machine interface or communication interface with external systems that is capable of supplying the acquisition module 12 with input data necessary for the operation of the system 10. The input data comprises, in particular, a starting point and an endpoint or a command for calculating an area that may be attained from the starting point.

The starting point corresponds, for example, to the current position of the aircraft and is provided by a navigation system thereof.

The endpoint is, for example, introduced by the pilot. This point corresponds, in particular, to a point on the ground and is, for example, chosen by the pilot from a database comprising the position of the airports close to the current position of the aircraft.

The calculation command for an attainable area is also introduced by the pilot when he wishes to obtain all the points attainable by the aircraft from, for example, the current position of the aircraft.

The unit 22 supplying the aircraft evolution context presents a set of internal and external monitoring systems of the aircraft capable of providing an internal evolution context of the aircraft and an external evolution context of the aircraft.

The internal evolution context of the aircraft comprises internal constraints of the aircraft susceptible to impact its trajectory. These internal constraints are, for example, defined by the operating state of various components of the aircraft. These operating states are determined or simulated (in particular by applying conditions of the “what-if” type known per se) by corresponding monitoring systems.

The external evolution context of the aircraft comprises external constraints of the aircraft susceptible to impact its trajectory. These external constraints include, in particular, three-dimensional obstacles present on the trajectory of the aircraft, external weather conditions, and the relief of the terrain overflown. These constraints come, for example, from one or more databases and/or corresponding monitoring systems.

The three-dimensional obstacles comprise, for example, real or imaginary objects in the environment of the aircraft, of different shape and structure. These objects may be, for example, a fixed landmark (mountain, electrical pylon, etc.) or a mobile obstacle (other aircraft, for example).

The database of standards 24 includes information relating to energy margins needed to perform different types of approach to the destination of the aircraft.

Each energy margin defines, in particular, a minimum fuel threshold required when the aircraft is approaching an endpoint. This threshold may be, for example, regulatory, and allow, in particular, for the circumventing of the aircraft near the endpoint.

The database 23 of strategies comprises, in particular, a predetermined strategy for circumventing three-dimensional obstacles.

This strategy may be, for example, defined before the flight, for example by the airline operating the aircraft, and comprising a plurality of rules defining the manner of circumventing three-dimensional obstacles.

According to an exemplary embodiment, this strategy for circumventing comprises a plurality of rules defining a vertical profile of the aircraft from a lateral profile. The vertical profile is calculated to respect the fuel margins provided by the database of standards 24.

Each rule defining a vertical profile of the aircraft may be, for example, chosen from the following list:
the trajectory is made at the optimum speed of the “long range” type, unless otherwise indicated;
the aircraft remains in its flight range (below the maximum altitude);
when the minimum fuel threshold is attained, the aircraft begins an “Idle” descent until it reaches the ground;
the aircraft climbs at the earliest to avoid all constraints (such as the relief of the terrain) that are above the aircraft and below the optimum altitude;
the aircraft climbs at the latest to avoid all constraints (such as the relief of the terrain) that are above the aircraft and below the optimum altitude;
the aircraft descends as soon as possible to the optimum altitude;
the aircraft descends at the latest towards the endpoint. If a constraint (such as the relief of the terrain) conflicts with this descent, the start of the descent is delayed so that it is no longer the case.

According to an exemplary embodiment, the strategy for circumventing comprises all of the aforementioned rules which may be, for example, implemented according to the order of priority defined by the aforementioned list. In this order, the highest priority rule is the first rule in the list and the lowest priority rule is the last rule in the list.

The first processing module 14 is able to process the data acquired by the acquisition module 12 in order to implement a method 100 for verifying the ability of the aircraft to attain an endpoint from a starting point.

The second processing module 16 is able to process the data acquired by the acquisition module 12 as well as the data processed by the first processing module 14 in order to implement a method 200 for determining an area on the ground that is attainable by the aircraft from a starting point.

Finally, the output module 18 is able to communicate all the data processed by the processing modules 14, 16 to the pilot via a suitable human-machine interface and/or to any other external system.

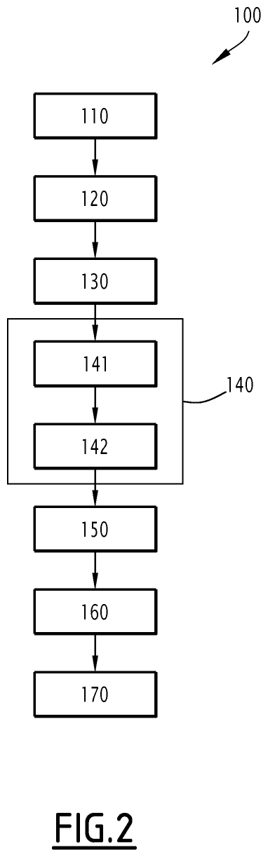

The method for verifying 100 will now be explained with reference to FIG. 2 showing a flowchart of its steps.

Initially, the pilot introduces into the input data unit 21 from a starting point, an endpoint for which verification of the ability of the aircraft to attain it is necessary. When the starting point is different from the current position of the aircraft, the pilot also introduces the starting point.

Then, the acquisition module 12 of the analysing system 10 acquires the starting point and endpoint coming from the unit 21, the external and internal evolution contexts of the aircraft coming from the unit 22, as well as the strategy for circumventing from the database 23 and a necessary fuel margin from the database of standards 24.

During an initial step 110 of the method, the acquisition module 12 provides the starting point and the endpoint to the first processing module 14, as well as the strategy for circumventing three-dimensional obstacles.

In the next step 120, the acquisition module 12 provides the external evolution context of the aircraft to the first processing module 14.

In the next step 130, the acquisition module 12 provides the internal evolution context of the aircraft to the first processing module 14.

In the next step 140, the first processing module 14 calculates a trajectory of the aircraft between the starting point and the endpoint according to the external evolution context and the internal evolution context of the aircraft, and according to the strategy for circumventing three-dimensional obstacles.

In particular, this step 140 comprises a first substep 141 and a second substep 142.

During the first sub-step 141, the first processing module 16 calculates a lateral profile of the aircraft possibly according to the external evolution context and the internal evolution context of the aircraft.

This lateral profile corresponds, for example, to a projection of a straight line connecting the starting point and the endpoint on a horizontal plane.

During the second substep 142, the first processing module 16 calculates a vertical profile of the aircraft according to the external evolution context and the internal evolution context of the aircraft and by applying the predetermined strategy for circumventing three-dimensional obstacles.

At the end of step 140, the trajectory of the aircraft then comprises the lateral profile and the vertical profile thereof.

According to another embodiment, during this step 140, the first processing module 14 directly calculates a three-dimensional trajectory of the aircraft between the starting point and the endpoint as a function of the external evolution context and the internal evolution context of the aircraft and according to the strategy for circumventing three-dimensional obstacles.

Moreover, when it is not possible to determine any trajectory between the starting point and the endpoint, during this step 140, the first processing module 14 determines a point on the ground located closest to the endpoint so that there is a trajectory between the starting point and this point on the ground.

In the next step 150, when there is at least one trajectory between the starting point and the endpoint, the first processing module 14 estimates a surplus of energy of the aircraft at the endpoint from the trajectory calculated during step 140.

In particular, the estimated surplus of energy comprises the amount of energy remaining at the endpoint and the potential energy of the aircraft. The potential energy is defined by the altitude of the aircraft.

In the next step 160, the first processing module 14 associates an attainability state of the endpoint as a function of the estimated surplus of energy. Each attainability state is chosen between an attainable state or a non-attainable state, wherein the attainable state is chosen when there is at least one trajectory between the starting point and the endpoint and the non-attainable state is chosen in the opposite case.

In addition, the attainability state of the endpoint is additionally determined according to the surplus of energy. In particular, this state is determined to be attainable when the estimated fuel quantity determined by the surplus of energy at this point is greater than the energy threshold derived from the database of standards 24.

During the final step 170 of the method, the first processing module 14 transmits the determined attainability state to the output module 18 which communicates it to the pilot or to any other external system.

The method for determining 200 an attainable area on the ground will now be explained.

This method 200 is implemented when the input data unit 21 acquires a calculation command of an area attainable from the starting point and transmitted by the pilot.

The unit 21 then transmits this command to the acquisition module 12 of the analysing system 10 possibly with the starting point if it is different from the current position of the aircraft.

Then, the acquisition module 12 transmits these data to the second processing module 16 which iteratively implements the method for verifying 100 explained above for said starting point and for an endpoint, a different endpoint being chosen for each new iteration of the method for verifying.

To do this, according to an exemplary embodiment, the second processing module 16 selects a plurality of endpoints, while, for each endpoint of this plurality, it implements the method for verifying 100 with the aid of the first processing module 14. The attainable area is then composed of all the endpoints offering the attainable state.

According to an advantageous embodiment of the invention, to do this, the first module implements a plurality of steps explained below with reference to FIG. 3.

In particular, during step A), the second processing module 16 propagates the aircraft from the starting point.

“Propagation of an aircraft” means the formation of a plurality of radii around the starting point of the aircraft, an endpoint on the ground having the non-attainable state being determined for each radius. The non-attainable state of the point of contact is determined by implementing the method for verifying 100 by the first processing module 14 in which the lateral profile of the aircraft is calculated as a part of the radius during the first sub-step 141 of the step 140.

Then, the second processing module 16 analyzes the vertical profile corresponding to the said point having the non-attainable state and defines the point of contact of this profile with the ground.

In other words, during step A), the second processing module 16 chooses on each radius (also called radial), a point sufficiently distant from the starting point so that its vertical projection on the ground corresponds to a point having a non-attainable state. This non-attainable state is determined by implementing the method for verifying 100 by the first processing module 14. The point having the non-attainable state thus gives a point of contact with the ground which corresponds to the point of contact of the corresponding trajectory with the ground.

Then, during step B), the second processing module 16 determines a boundary formed by one and several lines passing through all the points of contact.

In particular, when during this step B), at least one line forming the boundary has a unclosed line, the second processing module 16 determines one or more discontinuity segments. Each discontinuity segment comprises the two ends of the same line when a single unclosed line is determined, or two ends close to different lines when more than one unclosed line is determined.

Then, the second processing module 16 again implements step A) for each discontinuity segment, wherein the end of this segment having the largest potential energy is considered as the starting point. Then, the second processing module 16 again implements step B) until the, or each, line forming the boundary is closed.

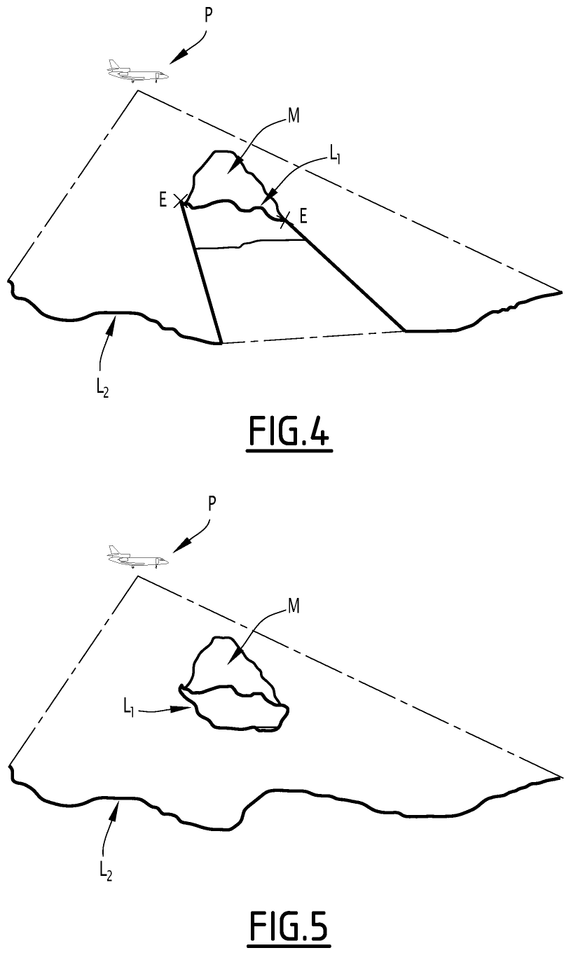

Different iterations of step B) are schematically illustrated in FIGS. 4 and 5.

In particular, these figures illustrate an aircraft P flying over a mountain M.

During a first iteration of the steps A) and B) illustrated in FIG. 4, the propagation is made from the starting point corresponding to the current position of the aircraft P and two unclosed lines L₁ and L₂ and two discontinuity segments are obtained.

In particular, in FIG. 4, each discontinuity segment has one of the straight lines connecting the ends of the unclosed lines L1 and L2. On each of these segments, the end E of the line L₁ offers higher potential energy than the corresponding end of the line L₂.

Then, step A) is thus reiterated for each end E of the line L₁, wherein this end is considered as the starting point. Then, step B) is again implemented.

FIG. 5 illustrates the result of several iterations of steps A) and B). As may be seen in this figure, the resulting boundary comprises two closed lines L₁ and L₂.

During the final step C), the second processing module 16 determines the area attainable from the starting point of the aircraft by the area delimited by the boundary. Thus, in the example of FIG. 5, the attainable area is between the closed lines L₁ and L₂.

It will be appreciated that the present invention offers a number of advantages.

First, the invention makes it possible to find a trajectory of the aircraft from a starting point to an endpoint by applying a strategy for circumventing three-dimensional obstacles. This then makes it possible to obtain predications at the endpoint that are very close to reality, and to estimate the surplus of energy at this point.

This estimate makes it possible to classify the endpoint as an attainable point or not, while taking into account the strategy for circumventing three-dimensional obstacles imposed, for example, by the airline. This strategy may be directly proposed to the crew via the database 23 so that the trajectory of the aircraft does not conflict with the requirements of the airline.

The invention therefore may implement the appropriate strategies in a customized manner for each company or crew.

Finally, the iterative implementation of the method for verifying according to the invention for different endpoints makes it possible to determine an area that may be attained from the starting point; this offers a particular advantage during, for example, the diversion of the aircraft to another airport.

1. Method for verifying the ability of an aircraft to attain an endpoint starting point; the method comprising the following steps:
supplying an external evolution context of the aircraft comprising external constraints of the aircraft susceptible to impact the trajectory of the aircraft between the starting point and the endpoint, the external constraints including three-dimensional obstacles;
providing an internal evolution context of the aircraft comprising internal constraints of the aircraft susceptible to impact the trajectory of the aircraft between the starting point and the endpoint;
calculating a trajectory of the aircraft between the starting point and the endpoint as a function of the external evolution context and the internal evolution context of the aircraft and according to a predetermined strategy for circumventing three-dimensional obstacles;
when there is at least one trajectory between the starting point and the endpoint, estimating from the calculated trajectory, a surplus of energy of the aircraft at the endpoint;
association of an attainability state to the endpoint, each attainability state being chosen between an attainable state or a non-attainable state, the attainable state being chosen when there is at least one trajectory between the starting point and the endpoint, and the non-attainable state being chosen in the opposite case.

2. Method for verifying according to claim 1, wherein the step of associating a state at the endpoint is implemented furthermore as a function of a required energy margin at the endpoint.

3. Method for verifying according to claim 1, wherein the external constraints further include the external weather conditions and the relief of the terrain between the starting point and the endpoint.

4. Method for verifying according to claim 1, wherein the internal constraints of the aircraft are defined by the operating state of different components of the aircraft.

5. Method for verifying according to claim 1, wherein the predetermined strategy for circumventing three-dimensional obstacles comprises plurality of rules defining a vertical profile of the aircraft related to a lateral profile; and
wherein the step of calculating a trajectory of the aircraft between the starting point and the endpoint comprises the following substeps:
calculation of a lateral profile of the aircraft according to the external evolution context and the internal evolution context of the aircraft;
calculation of a vertical profile of the aircraft according to the external evolution context and the internal evolution context of the aircraft and applying the predetermined strategy for circumventing three-dimensional obstacles to the lateral profile of, the aircraft.

6. Method for determining an area on the ground attainable by an aircraft from a starting point comprising the iterative implementation of the method for verifying according to claim 1 for said starting point and for a ground endpoint, wherein a different endpoint is chosen for each new iteration of said method for verifying.

7. Method for determining according to claim 6, wherein the predetermined strategy for circumventing three-dimensional obstacles comprises plurality of rules defining a vertical profile of the aircraft related to a lateral profile; the method for determining comprising the following steps:
A) propagation of the aircraft from the starting point comprising the following substeps:
formation of a plurality of radii around the starting point of the aircraft;
for each radius, identification of a ground endpoint having the non-attainable state, the non-attainable state of said point of contact being determined by implementing the method for verifying,
wherein the predetermined strategy for circumventing three-dimensional obstacles comprises a plurality of rules defining, a vertical profile of the aircraft related to a lateral profile; and
wherein the step of calculating a trajectory of the aircraft between the starting point and the endpoint comprises the following substeps:
calculation of a lateral profile of the aircraft according to the external evolution context and the internal evolution context of the aircraft;
calculation of a vertical profile of the aircraft according to the external evolution context and the internal evolution context of the aircraft and applying the predetermined strategy for circumventing three-dimensional obstacles to the lateral profile of the aircraft;
wherein the lateral profile of the aircraft being calculated as a part of said radius;
for each endpoint having the non-attainable state, analysis of the vertical profile and identification of a point of contact with the ground of this profile;
B) determining a boundary formed by one and several lines passing through all the points of contact;
C) delimitation of the area attainable by the boundary.

8. Method for determining according to claim 7, wherein when in B) at least one line forming the boundary has an unclosed line, step A) is again implemented for one of the ends of the unclosed line considered as the starting point during this implementation, step B) then being implemented again until the, or each, line forming the border is closed.

9. Computer program product comprising software instructions which, when implemented by computer equipment, implement a method for determining an area on the ground attainable by an aircraft from a starting point comprising the iterative implementation of a method for verifying for said starting point and for a ground endpoint, wherein a different endpoint is chosen for each new iteration of said method for verifying;
said method for verifying comprising the following steps:
supplying an external evolution context of the aircraft comprising external constraints of the aircraft susceptible to impact the trajectory of the aircraft between starting point and the endpoint, the external constraints including three-dimensional obstacles;
providing an internal evolution context of the aircraft comprising internal constraints of the aircraft susceptible to impact the trajectory of the aircraft between the starting point and the endpoint;
calculating a trajectory of the aircraft between the starting point and the endpoint as a function of the external evolution context and the internal evolution context of the aircraft and according to a predetermined strategy for circumventing three-dimensional obstacles;
when there is at least one trajectory between the starting point and the endpoint, estimating from the calculated trajectory, a surplus of energy of the aircraft at the endpoint;
association of an attainability state to the endpoint, each attainability state being chosen between an attainable state or a non-attainable state, the attainable state being chosen when there is at least one trajectory between the starting point and the endpoint, and the non-attainable state being chosen in the opposite case.

10. Aircraft capacity analysis system comprising means designed to determine an area on the ground attainable by an aircraft from a starting point comprising the iterative implementation of a method for verifying for said starting point and for a ground endpoint, wherein a different endpoint is chosen for each new iteration of said method for verifying;
said method for verifying comprising the following steps:
supplying an external evolution context of the aircraft comprising external constraints of the aircraft susceptible to impact the trajectory of the aircraft between th starting point and the endpoint, the external constraints including three-dimensional obstacles;
providing an internal evolution context of the aircraft comprising internal constraints of the aircraft susceptible to impact the trajectory of the aircraft between the starting point and the endpoint;
calculating a trajectory of the aircraft between the starting point and the endpoint as a function of the external evolution context and the internal evolution context of the aircraft and according to a predetermined strategy for circumventing three-dimensional obstacles;
when there is at least one trajectory between the starting point and the endpoint, estimating from the calculated trajectory, a surplus of energy of the aircraft at the endpoint;
association of an attainability state to the endpoint, each attainability state being chosen between an attainable state or a non-attainable state, the attainable state being chosen when there is at least one trajectory between the starting point and the endpoint, and the non-attainable state being chosen in the opposite case.
